(19) United States
(12) Patent Application Publication
(10) Pub. No.: US 2018/0338640 A1
(43) Pub. Date: Nov. 29, 2018

(54) STOVE

(71) Applicant: Chia-Ming Liu, Douliou City (TW)

(72) Inventor: Chia-Ming Liu, Douliou City (TW)

(21) Appl. No.: 15/682,815

(22) Filed: Aug. 22, 2017

(30) Foreign Application Priority Data
May 27, 2017 (CN) 201720606844.X

(51) Int. Cl. A47J 37/07; A47J 37/04

(52) U.S. Cl. CPC A47J 37/0704; A47J 2037/0795; A47J 37/079; A47J 37/04

(57) ABSTRACT

A stove includes a heating unit, an adjustment unit and a grill grate. The adjustment unit includes two lifting units, a synchronizer, and a drive unit. Each lifting unit has a screw rod, a sliding block movable along the screw rod, and a lift frame mounted to the sliding block. The synchronizer connects the lifting units. The drive unit is connected to the screw rod of one of the lifting units and is operable to drive synchronized rotation of the screw rods through the synchronizer. The grill grate is supported by the lift frames for moving between a first position, where the grill grate is proximate to the heating unit, and a second position, where the grill grate is distal from the heating unit.

### CROSS-REFERENCE TO RELATED APPLICATION

This application claims priority of Chinese Patent Application No. 201720606844.X, filed on May 27, 2017.

### FIELD

The disclosure relates to a stove and more particularly to a stove for grilling a food material.

### BACKGROUND

Generally, when using a conventional stove for grilling, a food material is placed on a grill grate of the conventional stove, and a heating source (such as burned charcoal, a gas heater, or an infrared heater) is disposed at a bottom portion of a main body of the conventional stove under the grill grate for heating the food material.

However, since a distance between the heating source and the grill grate is fixed, when using charcoal as the heating source (which implies that the magnitude and uniformity of heating are not conveniently adjustable), the food material may be cooked unevenly. Furthermore, the conventional stove is incapable of smoking the food material.

### SUMMARY

Therefore, an object of the disclosure is to provide a stove that can alleviate at least one of the drawbacks associated with the abovementioned prior art.

Accordingly, the stove includes a base seat, a top seat, a heating unit, an adjustment unit and a grill grate. The base seat includes a seat body. The top seat is disposed on top of the seat body. The heating unit is disposed at bottom of the top seat. The adjustment unit includes two lifting units, a synchronizer, and a drive unit. The two lifting units are respectively disposed at two opposite sides of the top seat. Each of the lifting units has a screw rod, a sliding block that is engaged with and driven by the screw rod to move upward or downward therealong, and a lift frame that is mounted onto the sliding block for concurrent movement therewith. The synchronizer connects the two lifting units. The drive unit is connected to the screw rod of one of the lifting units, and is operable to drive synchronized rotation of the screw rods of the lifting units through the synchronizer, thereby moving the sliding blocks of the lifting units together with the lift frames of the lifting units along the screw rods. The grill grate is disposed above the heating unit and supported by the lift frames for moving between a first position, where the grill grate is proximate to the heating unit, and a second position, where the grill grate is distal from the heating unit.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of an embodiment of a stove according to the present disclosure;

FIG. 2 is a partial exploded perspective view of the embodiment;

FIG. 3 is a fragmentary perspective view of the embodiment;

FIG. 4 is an enlarged section view of FIG. 3;

FIG. 5 is a fragmentary frontal view of the embodiment, illustrating a grill grate of the embodiment at a first position;

FIG. 6 is a view similar to FIG. 5, but illustrating the grill grate at a second position; and

FIG. 7 is a view similar to FIG. 1, but illustrating a top cover at a covered position.

### DETAILED DESCRIPTION

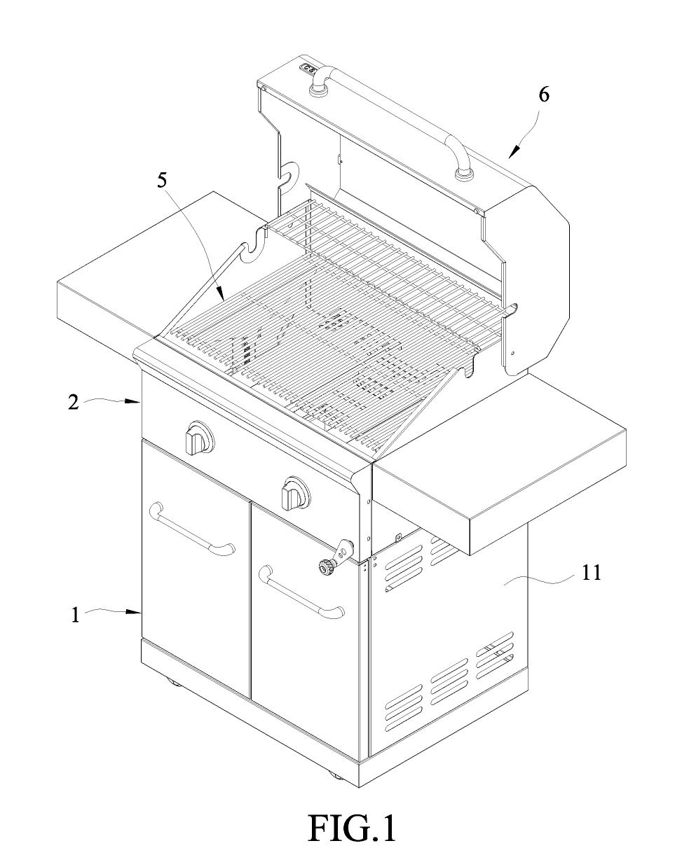

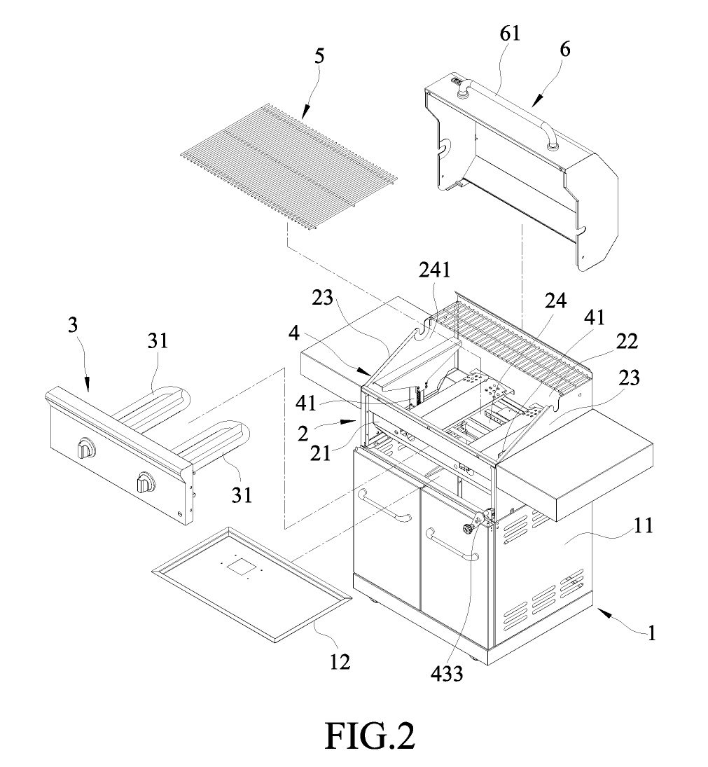

Referring to FIGS. 1 and 2, an embodiment of a stove according to the disclosure includes a base seat 1, a top seat 2, a heating unit 3, an adjustment unit 4, a grill grate 5, and a top cover 6.

The base seat 1 includes a seat body 11, and a drip pan 12 disposed on top of the seat body 11 and provided with a pan groove for catching material that drips from above, such as grease.

The top seat 2 has a front wall 21, a rear wall 22, and two opposite connecting walls 23 that are spaced apart from each other and connected between the front wall 21 and the rear wall 22. The front, rear and connecting walls 21, 22, 23 cooperatively bound a mounting space 24 that spatially communicates with the pan groove and that has an upper opening 241.

The heating unit 3 is disposed at bottom of the top seat 2 and includes a plurality of gas pipes 31 within the mounting space 24.

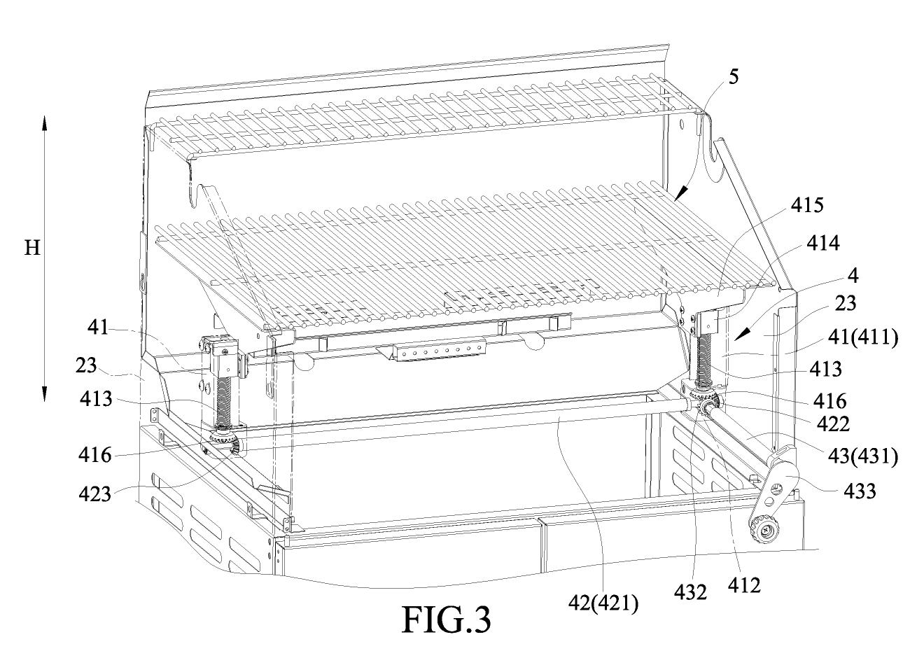

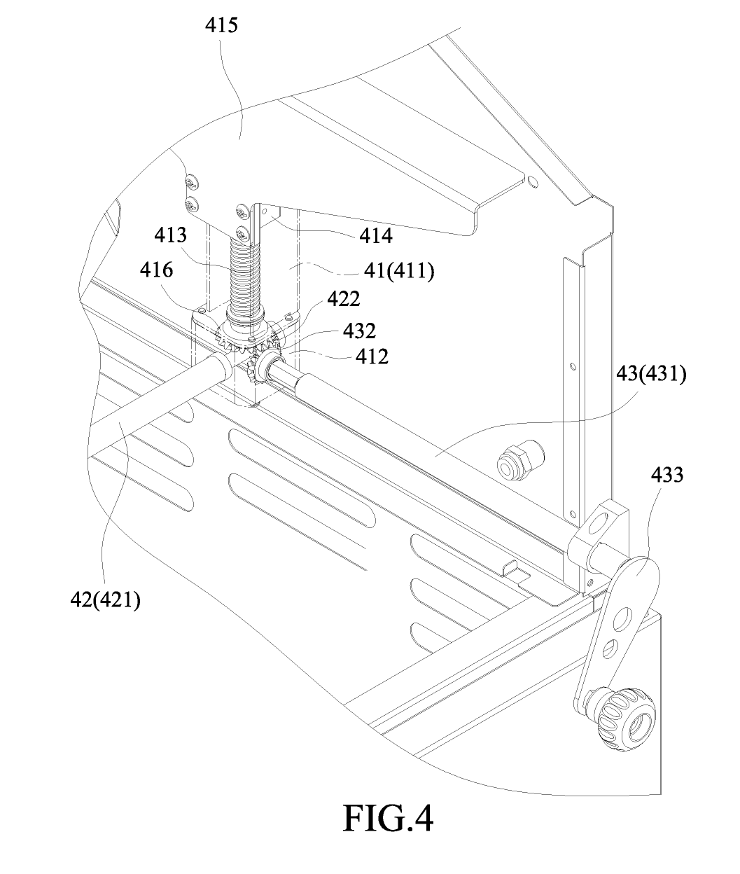

Referring to FIGS. 3 and 4, the adjustment unit 4 includes two lifting units 41 respectively disposed at the two connecting walls 23 of the top seat 2, a synchronizer 42 connecting the two lifting units 41, and a drive unit 43 rotatably mounted on the top seat 2. Each of the lifting units 41 has a fixed frame 411 fixed onto the respective one of the connecting walls 23, amounting seat 412 disposed at bottom of the fixed frame 411, a screw rod 413 rotatably mounted to the fixed frame 411, a sliding block 414 engaged with and driven by the screw rod 413 to move upward or downward therealong, a lift frame 415 mounted onto the sliding block 414 for concurrent movement therewith, and a screw rod gear 416 disposed at a bottom end of the screw rod 413. The synchronizer 42 is pivotally mounted to the mounting seats 412, connects the lifting units 41, and has a synchronizer bar 421, and a first synchronizer gear 422 and a second synchronizer gear 423, which are respectively disposed on two opposite ends of the synchronizer bar 421. The drive unit 43 has a drive shaft 431, a driving gear 432 disposed at one end of the drive shaft 431 and meshing with the first synchronizer gear 422, and a driving handle 433 disposed on the other end of the drive shaft 431 distal from the driving gear 432. The screw rod gear 416 of one of the lifting units 41 and the first synchronizer gear 422 of the synchronizer 42 simultaneously mesh with the driving gear 432 of the drive unit 43, and the second synchronizer gear 423 of the synchronizer 42 meshes with the screw rod gear 416 of the other one of the lifting units 41. In this embodiment, the screw rod gears 416, the synchronizer gears 422, 423, and the driving gear 432 are all bevel gears.

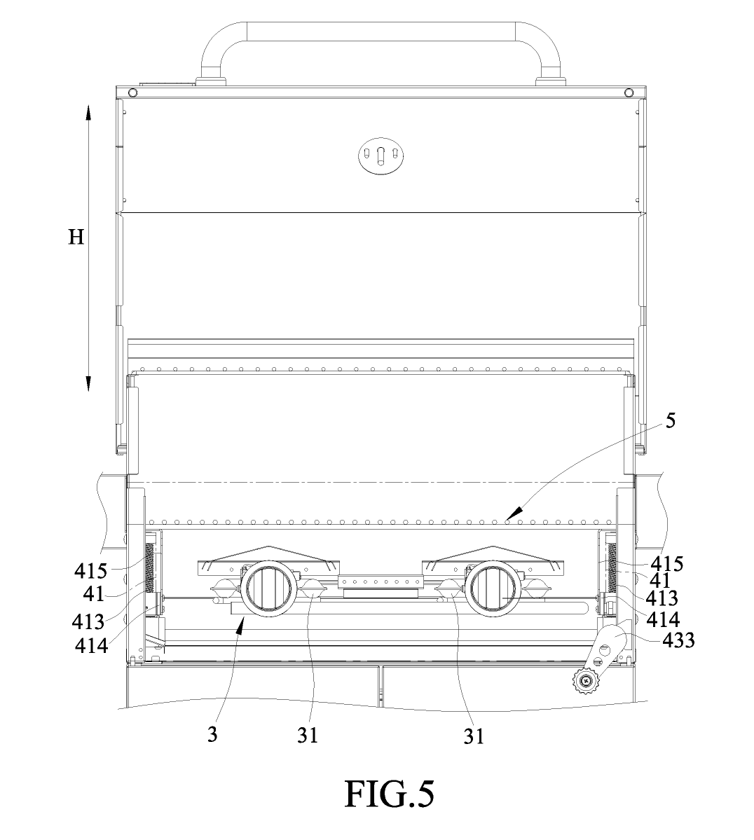

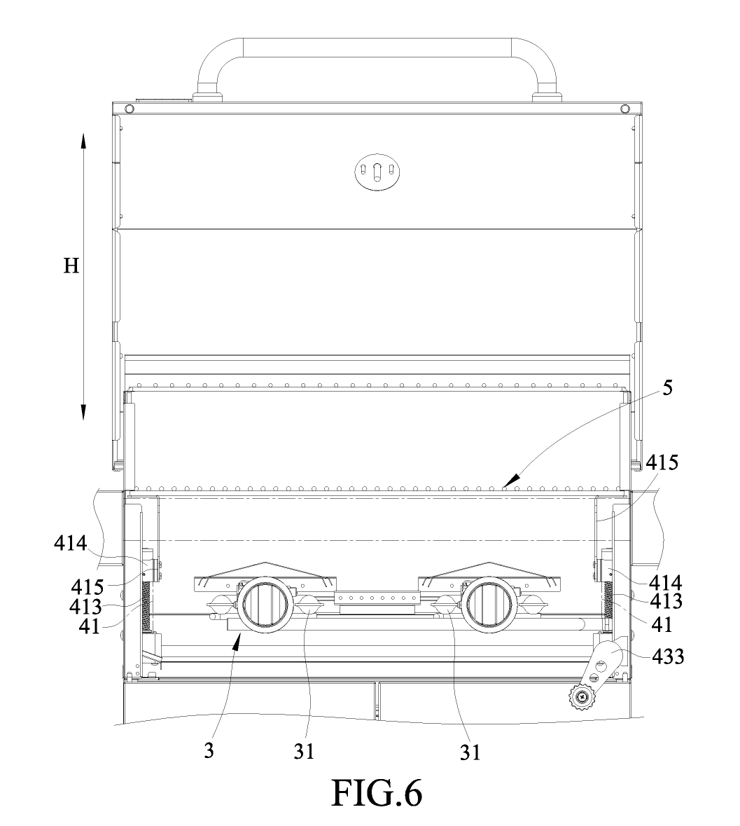

Referring to FIGS. 3 through 6, the grill grate 5 is disposed above the heating unit 3, and can be removably mounted on top of the lift frames 415 of the lifting units 41. During the use of the stove, a user can rotate the driving handle 433 to drive the drive shaft 431 and to drive the rotation of the screw rod 413 of one of the lifting units 41 through the interconnecting relationship between the driving gear 432 and the screw rod gear 416 of the one of the lifting units 41. In addition, given that the driving gear 432 meshes with the first synchronizer gear 422, and taking advantage of the interconnecting relationship of the second synchronizer gear 423 with the screw rod gear 416 of the other one of the lifting units 41, the drive unit 43 is operable to drive synchronized rotation of the screw rods 413 of the lifting units 41 through the synchronizer 42, thereby moving the sliding blocks 414 together with the lift frames 415 along the screw rods 413. With this in mind, the grill grate 5 can be moved between a first position (see FIG. 5), where the grill grate 5 is proximate to the heating unit 3, and a second position (see FIG. 6), where the grill grate 5 is distal from the heating unit 3.

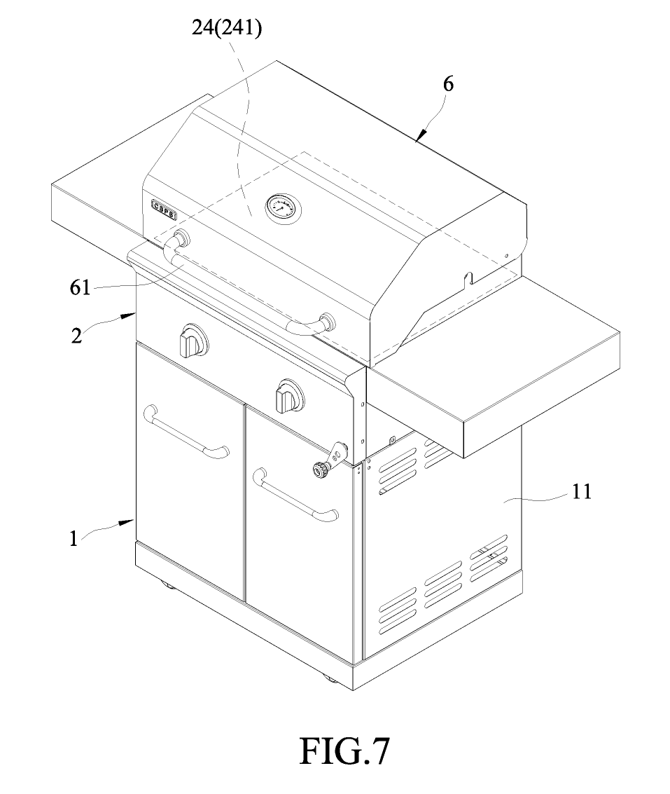

Referring to FIG. 7, the top cover 6 is pivotally connected to the top seat 2 and has a handle 61 that is operable to move the top cover 6 to open or close the mounting space 24. The user may choose to cover the opening 241 of the mounting space 24 such that a food material placed on the grill grate 5 can be smoked.

With the above description, the advantages of the stove according to the present disclosure can be summarized in the following:

1. The grill grate 5 can move between the first position and the second position, which allows for varying distance between the grill grate 5 and the heating unit 3, thereby allowing the user to better manage the grilling quality of the food material on the grill grate 5.

2. When the user moves the top cover 6 from a lifted position (see FIG. 1) to a covered position (see FIG. 7), the stove according to the present disclosure is capable of smoking the food material.

In the description above, for the purposes of explanation, numerous specific details have been set forth in order to provide a thorough understanding of the embodiment. It will be apparent, however, t one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that his disclosure is not limited to the disclosed embodiment but is intended to cover various arrangements included within the spirit and scope of the broadest interpretation so as to encompass all such modifications and equivalent arrangements.

What is claimed is:

1. A stove comprising:
a base seat including a seat body;
a top seat disposed on top of said seat body;
a heating unit disposed at bottom of said top seat;
an adjustment unit including
two lifting units respectively disposed at two opposite sides of said top seat, each of said lifting units having
a screw rod, a sliding block engaged with and driven by said screw rod to move upward or downward therealong, and a lift frame mounted onto said sliding block for concurrent movement therewith,
a synchronizer connecting said two lifting units, and
a drive unit connected to said screw rod of one of said lifting units and operable to drive synchronized rotation of said screw rods of said lifting units through said synchronizer, thereby moving said sliding blocks of said lifting units together with said lift frames of said lifting units along said screw rods; and
a grill grate disposed above said heating unit and supported by said lift frames for moving between a first position, where said grill grate is proximate to said heating unit, and a second position, where said grill grate is distal from said heating unit.

2. The stove as claimed in claim 1, wherein:
each of said lifting units has a screw rod gear disposed at a bottom end of said screw rod; said synchronizer has a synchronizer bar, and two synchronizer gears disposed on two opposite ends of said synchronizer bar and respectively meshing with said screw rod gears of said lifting units; and
said drive unit has a drive shaft, and a driving gear disposed at one end of said drive shaft and meshing with one of said synchronizer gears.

3. The stove as claimed in claim 2, wherein:
said screw rod gears, said synchronizer gears, and said driving gear are all bevel gears.

4. The stove as claimed in claim 1, wherein:
said top seat has a front wall, a rear wall, and two connecting walls that are spaced apart from each other and connected between said front wall and said rear wall, said front, rear and connecting walls cooperatively bounding a mounting space.

5. The stove as claimed in claim 4, wherein:
said lifting units further have
two fixed frames respectively fixed onto said connecting walls, and
two mounting seats respectively disposed at bottoms of said fixed frames;
said screw rods of said lifting units are respectively mounted to said fixed frames; and
said synchronizer is pivotally mounted to said mounting seats.

6. The stove as claimed in claim 2, wherein:
said drive unit further has a driving handle disposed on one end of said drive shaft distal from said driving gear.

7. The stove as claimed in claim 4, wherein:
said base seat further includes a drip pan disposed on top of said seat body and provided with a pan groove spatially communicated with said mounting space.

8. The stove as claimed in claim 4, wherein:
said heating unit includes a plurality of gas pipes within said mounting space.

9. The stove as claimed in claim 4, further comprising a top cover pivotally connected to said top seat, and having a handle that is operable to move said top cover to open or close said mounting space.
